(19) United States
(12) Patent Application Publication
(10) Pub. No.: US 2003/0040941 A1
(43) Pub. Date: Feb. 27, 2003

(54) Method of creating authorized, tax exempt municipal bonds used to replace a liability with insurance

(76) Inventor: Brian L. Whitworth, Malibu, CA (US)

Correspondence Address: Brian L. Whitworth, 3003 Sequit Dr., Malibu, CA, 90265, US

(21) Appl. No.: 09/935,818

(22) Filed: Aug. 23, 2001

(51) Int. Cl. G06F 17/60

(52) U.S. Cl. 705/4

(57) ABSTRACT

This application describes certain procedures for obtaining tax exempt status for interest paid on municipal bonds used to pay insurance premiums, approval procedures for bond issuance, and obtaining bond guarantees and ratings on bonds used to pay for insurance or finance a departure from self insurance or noninsurance.

### BACKGROUND OF THE INVENTION

1. Field of the Invention

The present invention relates to a method of creating one or more municipal bonds which are used to replace a liability with insurance. The method creates bonds with characteristics increasing the chances of being tax exempt, provides evidence used in obtaining a tax exempt opinion, reduces insurance premium taxes, facilitates approval for bond issuance, and facilitates obtaining favorable bond insurance or bond ratings.

2. Description of the Related Art

Tax Exempt Interest on Bond Financing of Insurance

Bonds issued by a U.S. “state or any political subdivision thereof” are currently exempt from federal income tax, subject to certain significant exceptions. Some exceptions relate to the bondholder. Tax exemption treatment related to the bonds themselves is dealt with in this application. Some factors relating to the tax exemption of a bond issue include: private or public purpose, arbitrage obtained due to borrowing at tax exempt rates, type of issuer, and certain “qualified” types of bonds.

IRS codes relating to tax exemption of interest on state and local bonds are attached for convenient reference: United States Codes, Title 26 (IRS Codes), Sections 103, 141, and 146-149 and the Code of Federal Regulations, Title 26 (IRS Regs), Volume 2, Section 1.148-10.

It is common for states to allow a tax exemption for interest on bonds issued by that state, or public entities within that state. Sample sections from the California Revenue and Taxation Code relating to taxation of bond interest are attached for reference.

Private letter rulings and court cases on a variety of topics relating to tax exemption of bond interest on other types of bonds have been issued over the years. These rulings, court cases, and relevant laws and regulations provide considerably guidance regarding factors which affect the likely tax treatment of any municipal bonds issued to pay for insurance premiums. Two objects of this application are: designing a bond transaction to facilitate tax exempt treatment, and performing analysis which provides support in the case for tax exemption.

As of the date of this application, no bonds have been issued to pay for insurance premiums for property, casualty, or employee benefit premiums. Therefore, there are no completed bond counsel opinions, IRS private letter rulings, state income tax rulings, or court cases relating to the tax exempt status of this exact type of bond.

Issued U.S. Pat. Nos. 6,009,402 and 6,026,364 from the current inventor assumed that tax exempt municipal bonds would be a common method of financing transactions such as departures from self insurance; those patents did not describe how such a tax exemption would be obtained, or specify steps for analysis relating to a making a case for tax exemption.

Arbitrage Bonds and Arbitrage Analysis

One factor which is often important in a case relating to tax exemption is whether a particular transaction constitutes arbitrage. Arbitrage bonds are defined in section 148 of the United States Codes Title 26 (IRS Codes) and described in greater detail in the Code of Federal Regulations Title 26 (IRS Regs).

One factor in demonstrating that a bond is NOT an arbitrage bond is “whether the action would reasonably be taken to accomplish the governmental purpose of the issue if the interest on the issue were not excludable from gross income under section 103(a)” (IRS Regs Section 1.148-10). Thus, if a bond would be pursued and issued even if it yielded taxable interest, that factor supports the case that a bond is not an arbitrage bond and supports the case for tax exemption.

Methods for calculating whether the present value of insurance with taxable bond financing is less than the present value of self insurance or noninsurance are described in this application.

In many cases, a public entity would pursue insurance with bond financing even at rates far above taxable interest rates. The Breakeven Interest Rate(s) shows how high interest rates must be in order to make the present value of insurance with bond financing equal to the present value of self insurance or noninsurance. In cases where the savings due to insurance are a large percentage of the cost of a self insured or uninsured liability, the breakeven interest rate may even be higher than an applicable usury rate for borrowing.

It is expected that demonstrating that insurance with bond financing would yield savings at the highest interest rates allowable under law would provide very strong evidence that a particular proposed bond is not an arbitrage bond.

Methods for calculating breakeven interest rates and comparing them with applicable or comparable usury rates are disclosed in this application.

Bond Approval Mechanisms

Municipal bonds are approved by a variety of mechanisms depending on factors such as: the type of borrowing, the purpose of the borrowing, the length of the bond issue, the type of public entity, and the state in which the public entity is located.

Some states allow or require a procedure known as a Validation Proceeding. In a validation proceeding, a public entity obtains a ruling that a proposed bond transaction is legal.

Validation proceedings have previously been used for various types of bond issues. An example is the use of California bond validation proceedings for the issuance of pension bonds. The primary distinctions for an insurance bond issue are: the purpose of the bond (moving from self insurance or noninsurance for a liability by purchasing insurance); the type of documentation such as savings from insurance, cash flows, tax exempt status of bond interest, or reduction in risk derived from the purchase of insurance using bond financing; the nature of the liability being replaced, and whether it is a debt imposed by law.

An overview of the California bond validation process from the California Debt and Investment Advisory Commission is attached. Relevant sections of the California Civil Code relating to validation proceedings are attached for reference.

Since to date there have been no bonds been issued to pay for replacing a liability with property, casualty, or employee benefit insurance, there have not been any validation proceedings confirming the legality of such bonds.

Methods related to bond validation proceedings are disclosed in this application.

In many cases, there are multiple alternative methods of obtaining approval for bond issuance. Using a validation proceeding may result in a higher bond rating and lower charges for bond interest or any bond guarantees.

Bond Ratings and Bond Guarantees

Most public offerings of municipal bonds are rated by one or more of bond rating agency, such as Standard & Poors, Moody's, or Fitch. Many privately placed municipal bonds are also rated.

Bond rating agencies have policies regarding ratings which may include how the bond is approved or authorized. In at least one case, a rating agency specifically provides a higher rating for bonds authorized through a validation proceeding than through certain other alternative methods. A copy of ______ from Moody's is attached for reference.

In recent years, about 40% of all municipal bonds have had bond insurance from companies such as AMBAC, FSA, MBIA, or FGIC. These companies are currently rated AAA by the major rating agencies, and their guarantee generally resulting in a AAA rating for a bond and reduces the issuer's interest cost. Charges for bond insurance generally are related to the bond issuer's underlying credit rating. Bond guarantee firms follow similar approaches to rating agencies, and may provide a lower guarantee fee for bonds approved through a validation proceeding than through other alternative approval methods.

Definitions

Self insurance: self insurance means setting reserves for a liability rather than purchasing insurance. Self insurance may or may not involve setting aside funds for future payment of liabilities which have been or will be incurred. It includes formal self insurance sanctioned by a regulatory authority such as workers compensation or automobile self insurance.

Uninsured: not covered by insurance. Includes self insured. In many cases, uninsured liabilities are also unknown, such as with hidden underground pollution.

Liability: a financial obligation, debt, claim, or potential loss. Many types of liabilities are not commonly insured. A few types of liabilities are by law uninsurable. For example, punitive damages are uninsurable in many states.

Partial insurance: some risks are partially insured. Examples include auto insurance with a $500 deductible, or product liability insurance with a per occurrence limit of $1 million. Portions of a liability which are not insured are uninsured and in some cases self insured.

### SUMMARY OF THE INVENTION

An exemplary preferred method according to the present invention includes one or more of the following steps: configuring a bond issue to increase the chance that it will yield tax exempt interest; analysis and documentation of whether a bond is an arbitrage bond; obtaining one or more legal opinions regarding the tax exempt status of the bond; obtaining approval for bond issuance; obtaining one or more bond ratings and bond guarantees; and issuing and making payments on the bond.

### DESCRIPTION OF THE DRAWINGS

Other objects, features and advantages of the invention will become readily apparent upon reference to the following detailed description when considered in conjunction with the accompanying drawings, in which like reference numerals designate like parts throughout the figures thereof, and wherein:

FIG. 1 is a high level, functional flowchart embodying of an exemplary preferred system and method according to the present invention;

FIG. 2 is a flowchart showing steps involved designing bond structure to increase chances of being tax exempt;

FIG. 3 is a flowchart showing steps involved in calculating the effect of tax exempt versus taxable interest payments on the bond;

FIG. 4 is a flowchart showing steps involved in obtaining private letter rulings, state tax rulings, or bond counsel tax exemption opinion;

FIG. 5 is a flowchart showing steps involved in approval procedures, such as a California Validation Proceeding;

FIG. 6 is a flowchart showing steps involved in obtaining bond guarantee insurance and obtaining one or more bond ratings;

FIG. 7. is a flowchart showing methods of calculating one or more breakeven interest rates or breakeven term structures for premium financing;

FIG. 8 is a sample output showing cash flows and present values for self insurance versus insurance with bond financing at tax exempt, taxable, and usury borrowing rates, using flat interest rates over the bond term;

FIG. 9 is a summary of taxable equivalent bond yields by state;

FIG. 10 is a sample output showing calculation of breakeven interest rates; and

FIG. 11 is a table showing various liabilities which might be insured.

### DETAILED DESCRIPTION OF THE PREFERRED EMBODIMENTS

An exemplary preferred embodiment of the present invention is adapted to create an index of residual value for groups of automobiles and to create related futures, options, and insurance products.

Major Inputs and Outputs

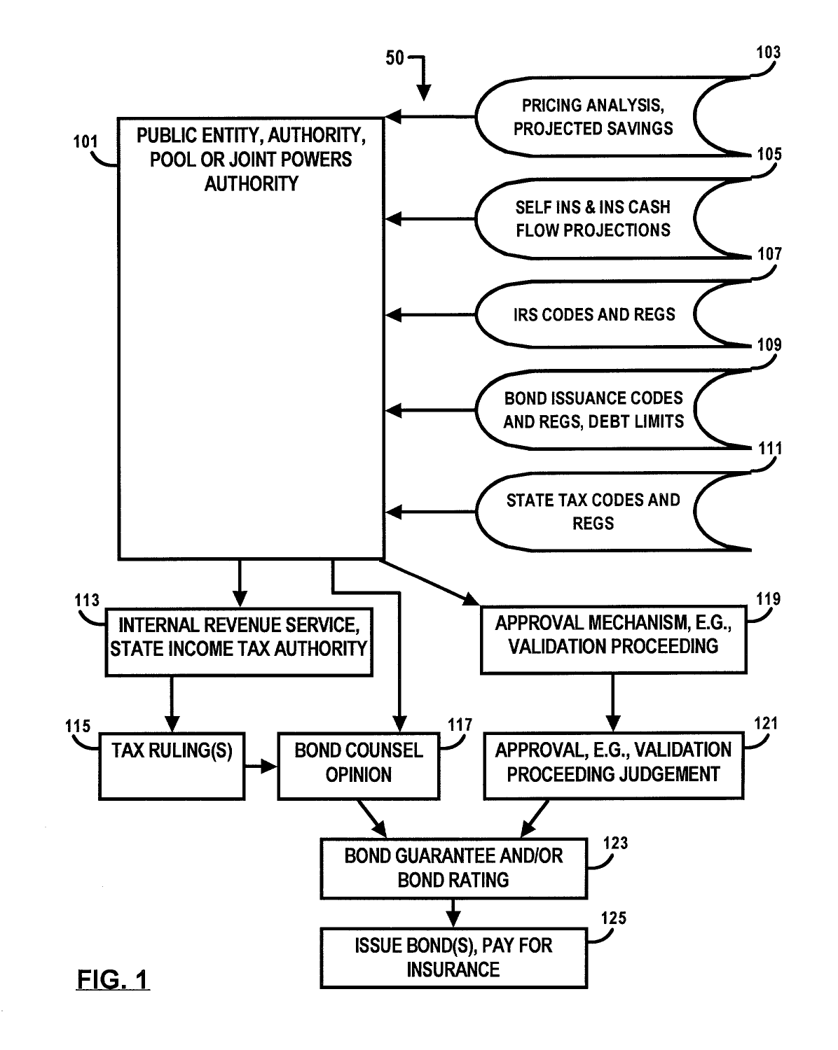

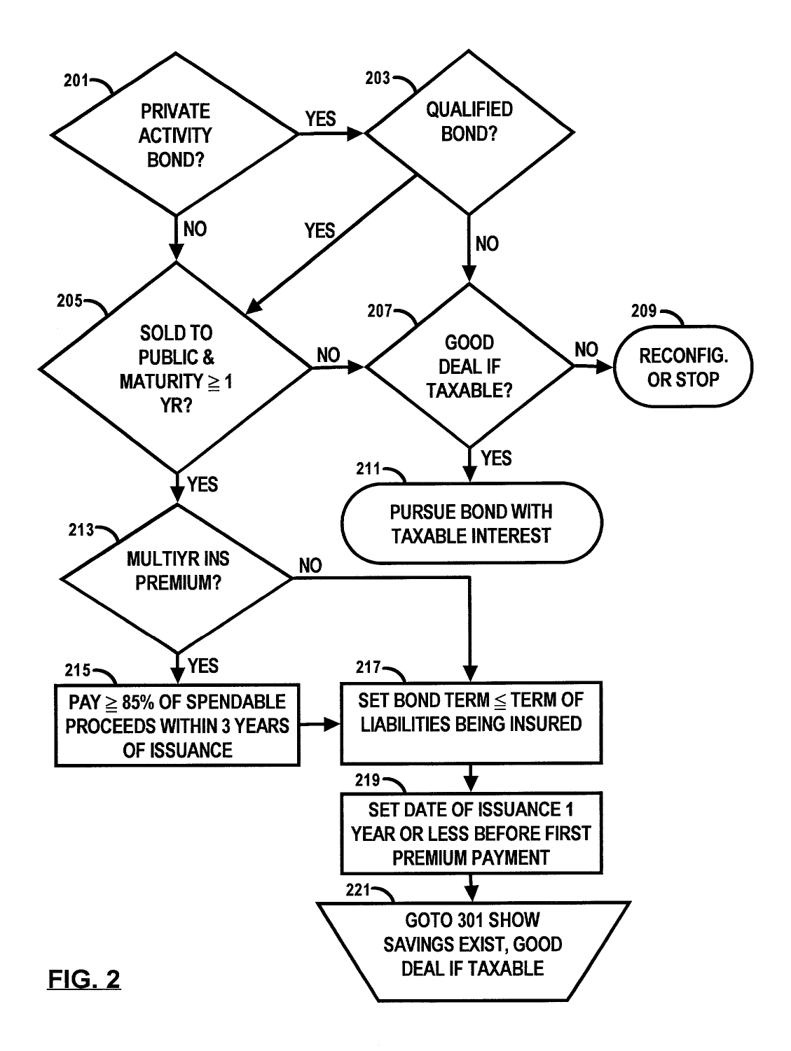

Referring to FIG. 1, an exemplary preferred system 50 according to the present invention includes a public entity, public authority (such as a port authority or airport authority), pool of public entities, or joint powers authority, 101. Information from various sources is conveyed to the public entity, public authority (such as a port authority or airport authority), pool of public entities, or joint powers authority, 101. This information includes: pricing analysis and projected savings of using insurance with premium financing instead of self insurance or being uninsured for a liability 103; cash flow projections for self insurance and insurance with premium financing 105; Internal Revenue Service (IRS) codes and regulations 107; bond issuance codes and regulations and debt limit codes and regulations 109; and state tax codes and regulations 111.

Information compiled by the public entity, public authority (such as a port authority or airport authority), pool of public entities, or joint powers authority 101 may be processed and used for filings or inquiries with the IRS and/or a state tax authority 113. The IRS and/or state tax authority may issue one or more rulings related to tax exemption of interest payments on bonds 115. Any such rulings 115 may be used by bond counsel 117 for counsel's tax opinion. Bond counsel 117 also might issue an opinion without any such rulings.

Many bond issues require an approval from outside the public entity, public authority (such as a port authority or airport authority), pool of public entities, or joint powers authority 101. Examples of such approvals are voter approval, state regulator approval, and court validation proceedings 119. Information compiled by the public entity 101 can be used by the voters, regulators, or courts providing approval 119 in their analysis or decisions regarding the bond issue. When approval is granted 121, such as after completion of a ballot, regulatory procedure, or validation proceeding, a bond guarantee and/or one or more bond ratings may be obtained 123. After any such guarantee or rating is obtained at step 123, one or more bonds are issued to pay for insurance 125.

Bond Structure and Tax Exempt Status

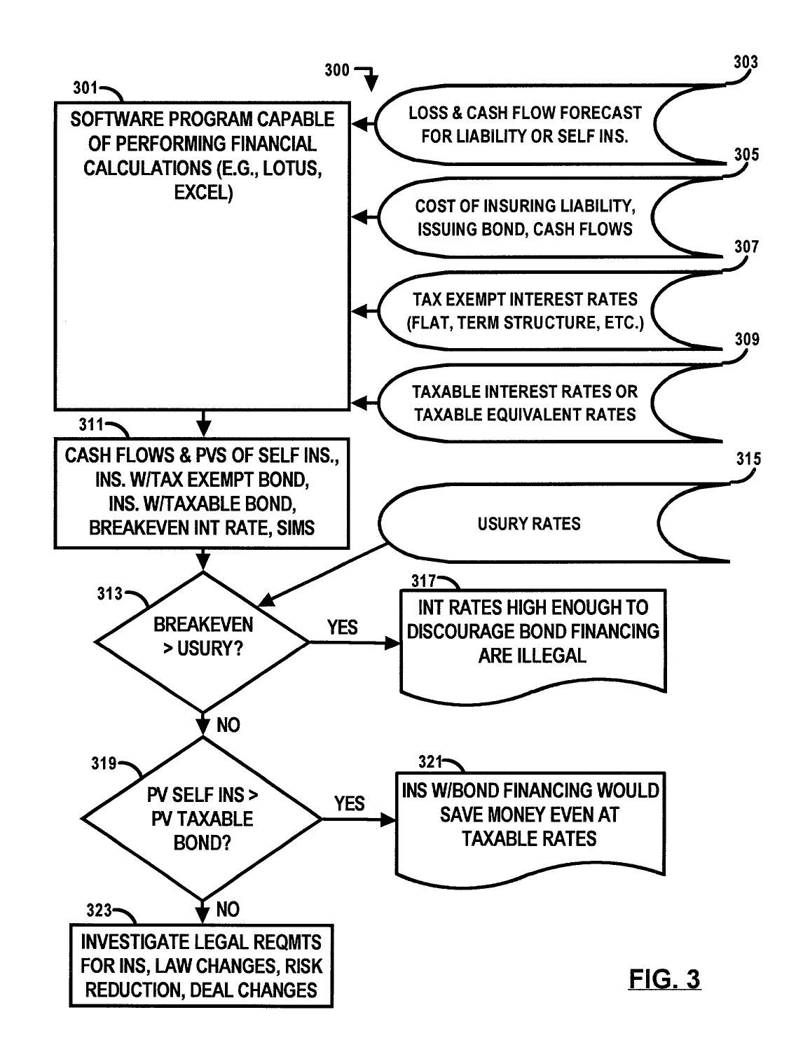

FIG. 2 illustrates steps used to increase chances of a bond used to pay insurance premium being tax exempt. These steps are primarily derived to comply with IRS codes relating to tax exemption of interest on state and local bonds: United States Codes, Title 26 (IRS Codes), Sections 103, 141, and 146-149 and the Code of Federal Regulations, Title 26 (IRS Regs), Volume 2, Section 1.148-10. A copy of these documents is attached for reference. It is common for states to allow a tax exemption for interest on bonds issued by that state, or public entities within that state. Sample sections from the California Revenue and Taxation Code relating to taxation of bond interest are attached.

At step 201 a check is performed to see if the proposed bond is a private activity bond. Private activity bonds are defined under section 141 of the IRS Code. The characteristics of private activity bonds are well known to those skilled in the art of municipal bond legal analysis and issuance. A “yes” at 201 advances to step 203. A “no” at 201 advances to step 205.

In certain defined circumstances which are well know to those skilled in the art of municipal bond legal analysis and issuance, a private activity bond can be a “qualified bond” which is eligible for tax exempt treatment. Qualified bonds are described under sections 141, 146 and 147 of the IRS Code. If the bond is a qualified private activity bond potentially eligible for tax exemption, a “yes” advances to step 205.

Another requirement for state and local bonds to be exempt from Federal taxation is that they be registered. The requirements for bonds to be registered are also well known to those in the field and described in section 149 of the IRS Code. Among bonds required to be registered are those sold to the U.S. public with maturities of one year or more. If the bond is not sold to the public, not sold to anyone in the U.S., or has a maturity of less than one year, a “no” at 205 advances to step 207. Otherwise, a “yes” at 205 advances to step 213.

At 207, a bond in its current expected form is unlikely to yield tax exempt interest. If the insurance with bond financing is still a good deal if taxable, a “yes” advances to step 211. The definition of “good deal” will most likely be at the discretion of the mayor, governor, board, or other governing entity of the bond issuer. In some circumstances, insurance might be a good deal even if it is expected to be more expensive than self insurance on average. For example, transfer of catastrophe risk, elimination of a moral hazard, or a legal requirement to fund a liability or purchase insurance might make taxable bonds for insurance a good deal, even if more expensive than the expected cost of self insuring.

At 211 a bond yielding taxable interest is pursued.

A “no” at 207 advances to step 209. If taxable bond financing raises interest expense enough that the currently proposed transaction is not a good deal, at 209 the public entity may decide to stop, and not pursue any transaction. The public entity might also attempt to reconfigure the deal in some way. Examples of reconfiguring include, but are not limited to: obtaining less expensive insurance; buying insurance with different limits or policy provisions; buying insurance for a shorter or longer policy term; waiting and including the bond as a qualified private purpose bond in a future year; changing the bond from unregistered to registered form; changing the term or cash flows of the bond; and waiting for market interest rates to drop.

A “yes” at step 205 advances to step 213, where a check is performed to see if the bond is financing insurance premium which will be paid over multiple years. If portions of the proceeds are kept for too long after the bond is issued, it may be classified as a “hedge bond”. The characteristics of hedge bonds are well known to those in the field of municipal bond law and underwriting. Hedge bonds are defined in IRS Code section 149 (g). If insurance premium will be paid over multiple years, a “yes” advances to step 215. A “no” advances to step 217.

For long multiyear insurance policies, such at five years or more, paying premium in equal amounts annually might run afoul of the hedge bond requirement. For example, a large construction project might last 10 years. If a bond was issued to pay workers compensation insurance premiums for 10 years, 10% of the bond proceeds might be used each year to pay premium. In order to avoid hedge bond treatment, at least 85% of the bond proceeds should be paid out within 3 years of the issue date. In some cases, an issuer would do multiple bond issues several years apart to comply with hedge bond requirements. The issuer might also prepay an insurance premium to comply with this requirement. In some cases, discounts for prepaying insurance premiums are very substantial, more than would be expected simply due to the time value of money or interest income of the insurance carrier.

At step 217, the bond term is set to be less than or equal to the term of the liabilities insured. This step is not strictly required by any current IRS code or regulation. Thus, this step is not required, but precautionary. There are general cautions about “overburdening the tax exempt market” by issuing bonds far in advance of the first payment from the proceeds (e.g., 1.148-10 of the IRS CFR), or issuing bonds which remain outstanding for longer than necessary.

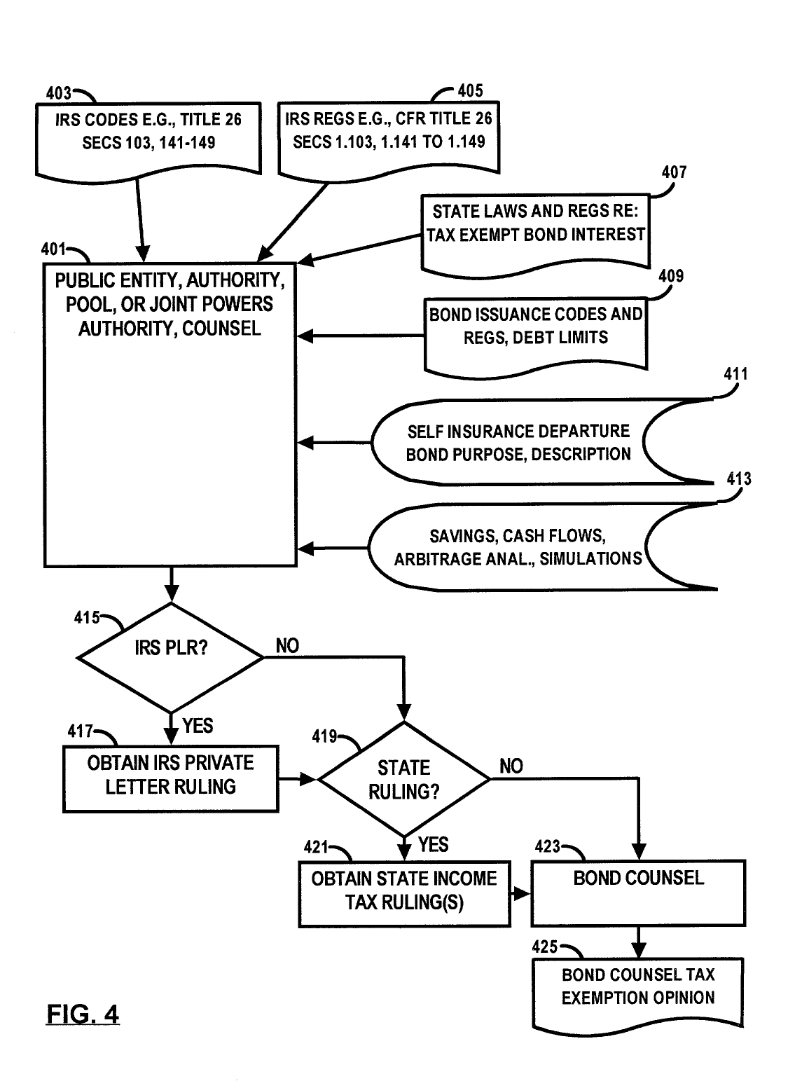

At step 219, the date of issuance of the bonds is set 1 year or less before the first premium payment using bond proceeds. Several sections of the IRS CFR are related to this step, including 1.148-1, 1.148-2, and 1.148-10. These requirements are well know to those in the field of municipal bond law and underwriting. At step 221, the process continues to step 301 of FIG. 3.

Analysis and Documentation of Whether a Bond is an Arbitrage Bond

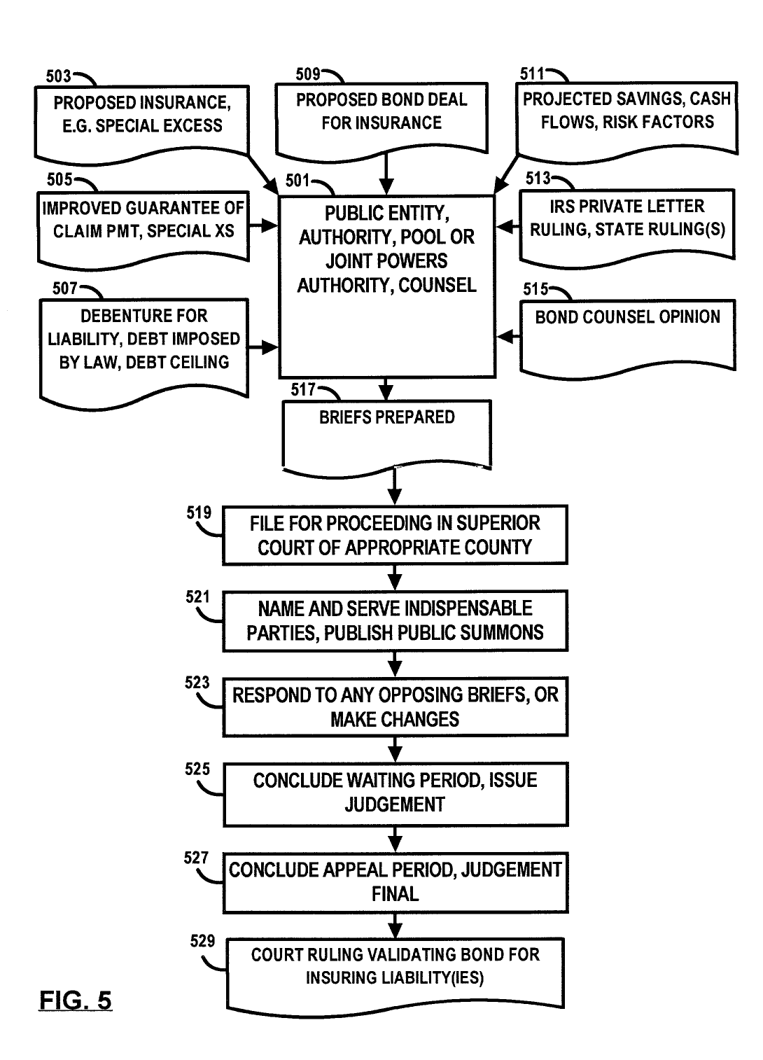

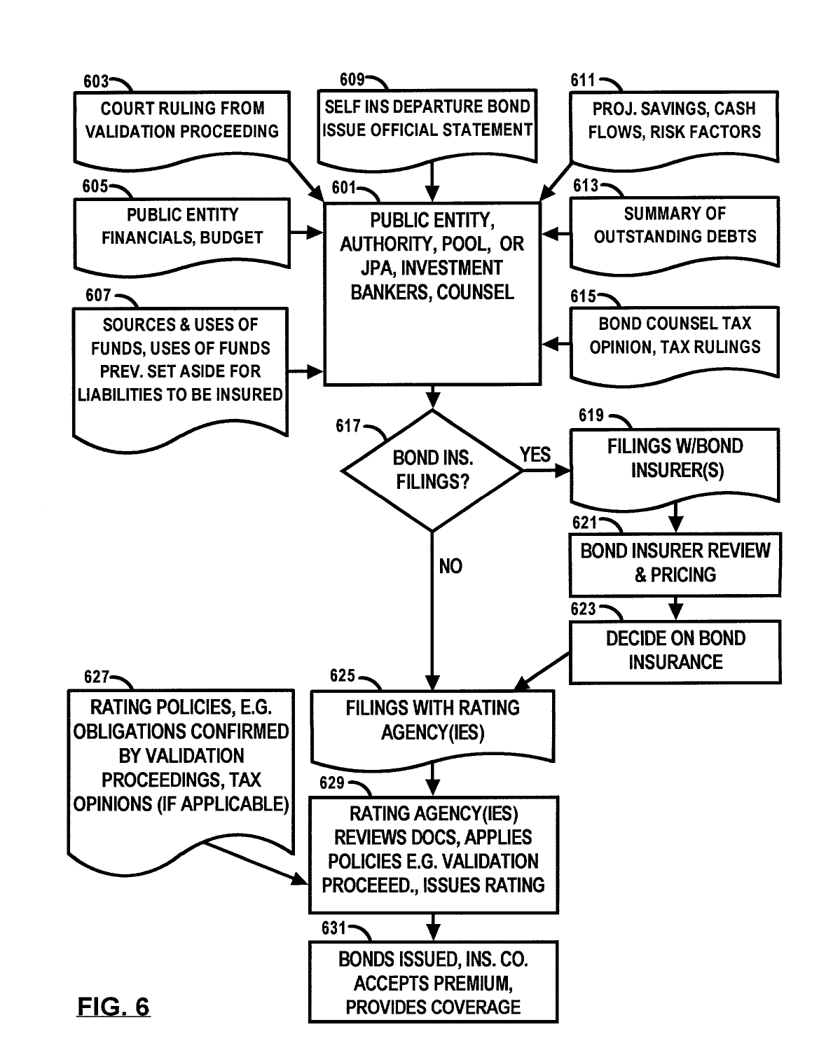

FIG. 3 is a flowchart showing methods of calculating and documenting that insurance and bond financing would either generate savings over self insurance, even if bond financing was taxable, or direct the public entity to document other reasons besides expected savings for pursuing insurance and a bond issue. Information from FIG. 3 can be used as evidence for tax exemption opinions and rulings, such as in FIG. 5, or for approval processes, such as in FIG. 4.

The system 300 includes a computer executable program which in a preferred embodiment is a spreadsheet program 301 such as a Lotus or Excel spreadsheet containing the software which manipulates the input data. It is technically possible to perform these calculations without a computer or software, such as with a handheld calculator, or even paper and pencil. However, hand calculations would be extremely laborious in many cases and are not a preferred embodiment.

Information regarding losses, forecast losses, and forecasts of cash flows for the liabilities if such liabilities were self insured or uninsured is input in 303. A common source of this information is an actuarial study.

The cost of insuring the liability and issuing one or more bonds, and cash flows associated with an insured program are input in 305.

Tax exempt interest rates expected for the bond issue are input in 307. Such rates might come from a market source for recent bond issues of similar term and rating. For example, a California public entity with a AA rating from Moody's seeking a 5 year tax exempt bond might use the interest rate term structure of a recent 5 year tax exempt bond issued by another AA rated CA public entity. Other potential sources of tax exempt interest rates include, but are not limited to: market sources, such as Bloomberg; a recent bond issuance by the same entity; a U.S. treasury term structure with a tax exempt spread adjustment; a bond underwriter or investment banker; and the Municipal Market Data Index (MMD). It is also possible to perform calculations with the term structure set as a constant flat rate. Flat rates can be supplied by a similar variety of sources to term structures.

Setting the term structure at a constant rate might be more common for preliminary analysis. In fact, the entire analysis can be done pro forma, with no actual insurance quote, a tax exempt bond rate which is approximate, a taxable interest rate which is approximate, and self insurance forecasts which are drafts, approximate, or uncertain guesses. The quality of the analysis increases with increased reliability of the inputs.

Robustness of savings forecasts can be tested with simulations. Any of the inputs can be allowed to vary and ranges of savings can be calculated. For example, simulations can be performed using a range of self insurance costs or various self insurance cash flow patterns. In cases where insurance with taxable bond financing shows substantial savings over even low end forecasts of self insurance costs, this shows substantial support for bonds not being “arbitrage bonds” and helps the case for tax exempt interest.

Another case where simulations are useful is for bonds with floating interest rates. In that case, simulations over a range of possible or likely interest rates can be performed.

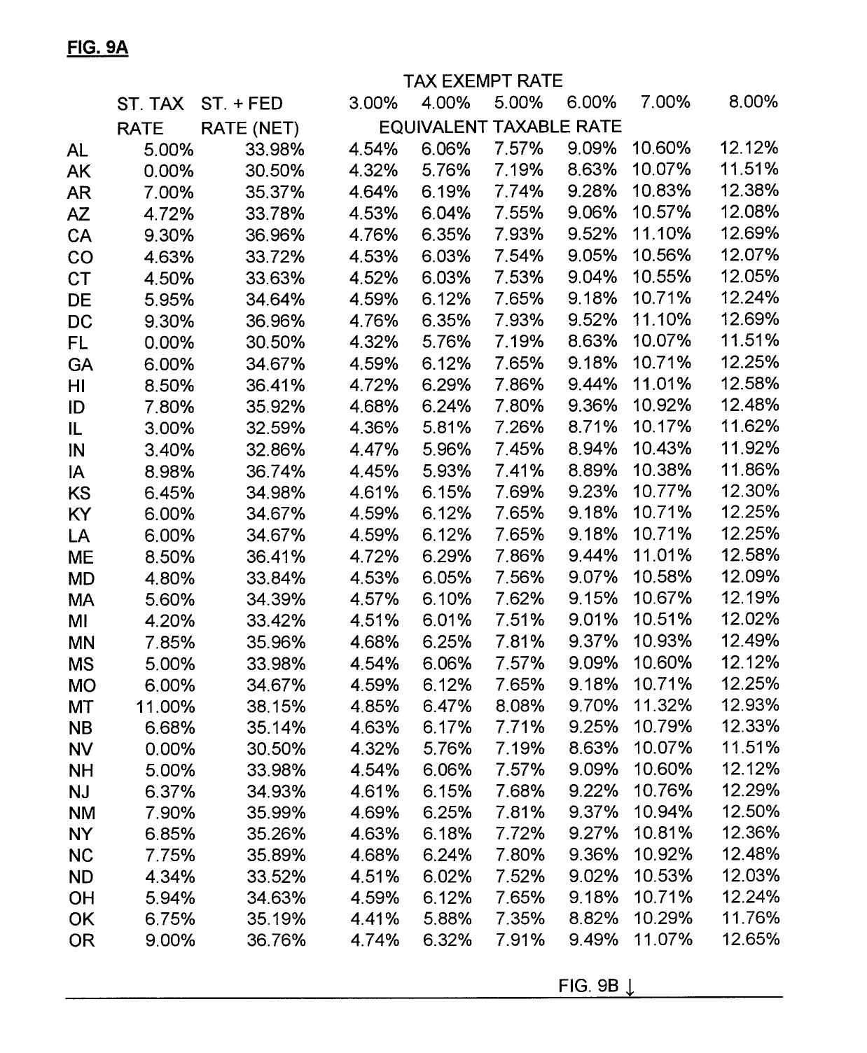

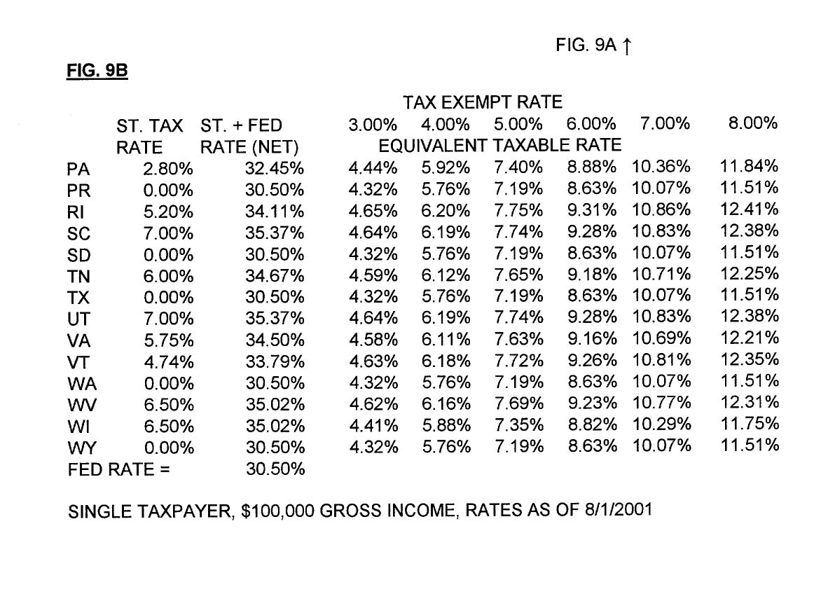

At 309 taxable interest rates for the same term, state and rating as the tax exempt parameters used in 307 are input. Alternatively, approximate expected taxable equivalent interest rates could be calculated from the applicable personal income tax rates of likely buyers of the bond. For example, for the year 2001, a single taxpayer living in California who has a gross income of $100,000 would have an overall marginal (net state and federal) tax rate of 36.963%. Thus, the expected equivalent yield for a California municipal bond which yields 5% tax exempt is 7.93% taxable; 7.93%=5.00%/(100%−36.963%). An exemplary table of taxable equivalent yields is in FIG. 9. Note that there are several states which do not currently have state income taxes.

The software program 301 calculates cash flows and present values for: self insurance; insurance with tax exempt bond financing; insurance with taxable bond financing; and a breakeven interest rate 311. The breakeven rate is the interest rate at which the present value of self insurance equals the present value of insurance with bond financing.

The breakeven interest rate can be obtained by multiple methods, including: using simulation, manual iteration by changing the interest rate(s), or by using software tools such as Excel's Solver or Lotus' Backsolver. Both the Excel and Lotus solver tools allow the user to specify the value of a particular cell and vary the values in certain other cells to obtain the specified value. For the breakeven rate, a cell containing the calculation of net savings of the present value of insurance with bond financing versus the present value of self insurance is set to zero. Then, other cells containing one or more interest rates are allowed to vary. One straightforward method of using the solver with a term structure of interest rates is to let all interest rates for various maturities rise or fall proportionately, i.e., if the interest rate for the first year doubles, the interest rate for all other years in the bond issue double. Similarly, all rates in the term structure can increase or decrease by the same constant, i.e., if the interest rate for the first period rises by 250 basis points, the interest rates for all other periods rise by 250 basis points.

The method of calculation of breakeven interest rates is similar for fixed and floating rate bonds. Simulations based on changes in market interest rates are especially useful for floating rate bonds.

Calculation of the breakeven interest rate is not required, but can be useful for showing that the proposed bond is not an arbitrage bond and should be tax exempt. This evidence is particularly strong when the breakeven rate is higher than the highest rate allowed to be charged by law, the applicable usury rate.

At step 313 a check is performed to see if the calculated breakeven interest rate is above the applicable usury rate(s) from input 315. In some cases, there will be no legally mandated usury rate. However, if the breakeven interest rate exceeds many usury rates for other borrowers or other jurisdictions, it will provide support that the proposed insurance with bond financing contains substantial savings regardless of interest rate. This is an element of demonstrating that a proposed bond financing does not “overburden the tax exempt market” and aids in making the case that a particular bond should be tax exempt. According to IRS CFR 1.148-10, “An important factor bearing on this determination is whether the action would reasonably be taken to accomplish the governmental purpose of the issue if the interest on the issue were not excludable from gross income under section 103(a) (assuming that the hypothetical taxable interest rate would be the same as the actual tax-exempt interest rate).”

If the breakeven interest rate is higher than the applicable usury rate, or is higher than usury rates for other borrowers or jurisdictions, a “yes” at 313 advances to step 317. At 317 documentation is created showing that interest rates high enough to make insurance with bond financing a breakeven deal with self insurance requires interest rates which are illegal, or are illegal for some borrowers or jurisdictions.

A “no” at step 313 advances to step 319. A 319 a check is performed to see if the present value of insurance with taxable bond financing is less expensive than the present value of self insurance. If the present value of insurance with bond financing is lower, this is support that the proposed tax exempt financing does not “overburden the tax exempt market” and a “yes” advances to step 321. At 321, documentation is created showing that at taxable interest rates, the entity would still save money by using insurance with taxable bond financing, instead of self insurance.

A “no” at step 319 advances to step 323. At 323, the entity may review legal requirements for purchasing insurance, changes in the law, risk reductions obtained through insurance, possible changes to the insurance deal or bond financing, or any other changes which might justify tax exempt bond financing.

Obtaining One of More Opinions Relating to Tax Exempt Status of a Bond

FIG. 4 is a flowchart showing methods of obtaining one or more legal opinions or rulings related to tax exemption of interest on bonds used to pay for insurance premium.

Information from various sources is conveyed to or assembled by the public entity, authority, pool, or joint powers authority, and their counsel 401. The information includes: Internal Revenue Service Codes, for example Title 26, Sections 103 and 141-149, input 403; Internal Revenue Service Regulations, for example CFR Title 26, Sections 1.103 and 1.141-1.149, input 405; state laws and regulations relating to taxation of interest on state and local bonds, for example California Revenue and Taxation Code Sections 17133 and 17133.5, input 407; bond issuance codes and regulations and debt limits, input 409; description of the self insurance departure bond(s), input 411; and savings, cash flows, arbitrage analysis or simulations, relating to self insurance and insurance with bond financing, such as might be produced from the process in FIG. 3, input 413.

Inputs 403-413 are analyzed and at step 415 a decision is made regarding whether to seek a private letter ruling from the Internal Revenue Service on tax exemption for the bond under consideration. Such a ruling is not required and currently most municipal bonds are issued without seeking such a ruling; opinions from bond counsel without a prior private letter ruling are more common. Bond counsel generally attempts to predict the tax treatment of interest on municipal bonds using similar statutes, regulations, and case law to those used by the IRS.

The first bonds of any type are more likely to be submitted for a private letter ruling. Bonds where the tax exempt or non-tax exempt status is more clear-cut are more likely to be issued without the cost and potential delays of seeking a private letter ruling. A “yes” at 415 advances to step 417, where a private letter ruling is obtained. The process then continues at step 419.

If no private letter ruling is sought, a “no” at 415 advances to step 419 where a decision is made regarding seeking a tax exemption opinion or ruling from the state where the issuer is located. In a few states which have personal income taxes, this decision need not be made and a “no” is assumed. A “no” for any reason at 419 advances to step 423 where bond counsel provides its opinion on the tax exempt status of interest on the bonds at the state and federal level. A “yes” at 419 advances to 421, where an opinion or ruling regarding tax exemption at the state level is sought and then the process continues at 423.

Bond counsel's completed legal opinion is output as a document at 425. This document is likely to become part of the bond official statement. Bond counsel opinion is also frequently used for other purposes such as: approval processes, seeking bond guarantees, and/or seeking bond ratings. Bond counsel opinion might also be included in briefs for any validation proceedings.

Bond Validation Proceedings

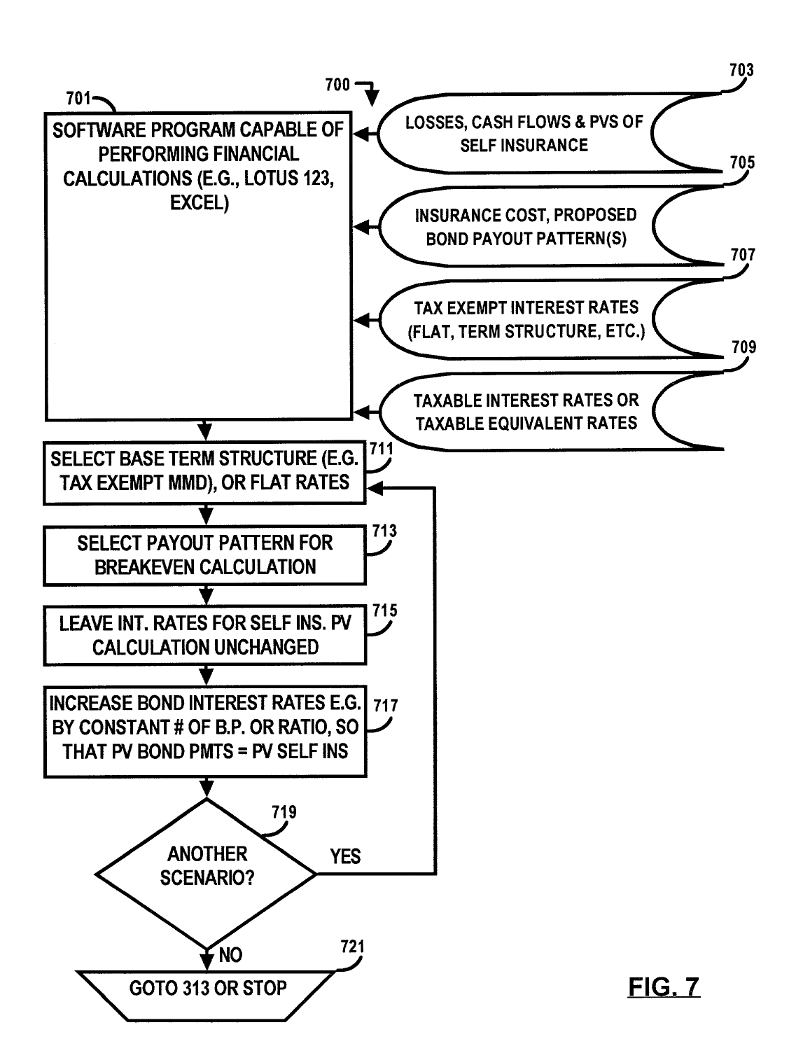

FIG. 5 is a flowchart showing methods of obtaining validation for a bond issuance through a court validation proceeding. Validation proceedings are used in some states to confirm the validity of proposed bond issues. In some states, these are referred to as “validation procedures”, or “validating proceedings” rather than “validation proceedings”. Among the states using validation proceedings are: California, Florida, Georgia and Utah. Validation proceedings enable public entities to confirm the legality of various actions, including contractual agreements and the issuance of public debts. Validation proceedings help avoid litigation relating to a bond issue. In many cases, they also help avoid debt limitations, or help obtain a favorable bond rating (see FIG. 6).

Information from various sources is conveyed to or assembled by the public entity, authority, pool, or joint powers authority, and their counsel 501. The information includes: the proposed insurance program which will be financed by the bonds, which may be for any type of insurance for past occurrences or future liabilities, input 503; documentation of improved guarantee of claim payment, such as might occur when the credit risk of a public entity is replaced by the credit risk of an insurer, or an insurance guarantee fund, input 505; a debenture, a certificate or voucher acknowledging a debt, and stating whether the debt is imposed by law, and any applicable debt ceilings, input 507; a summary of the proposed bond deal for insurance, input 509; savings, cash flows, arbitrage analysis or simulations, relating to self insurance and insurance with bond financing, such as might be produced from the process in FIG. 3, input 511; any IRS private letter ruling or state income tax rulings, input 513; and any bond counsel opinion, input 515.

As an example, if a city located in California might wish to insure its previously self insured workers compensation losses. The city could have both losses occurring in the future and losses which have already occurred but have not yet been paid. The insurance program for past and future workers compensation losses would be described in input 503.

Documentation of improved guarantee of claim payment could be included in input 505. In some cases, the improvement in guarantee is quite material. Starting in the year 2000, a new form of insurance is available to public entities in California. “Special Excess” workers compensation policies provide coverage for part or all of a formerly self insured public entity's workers compensation liability, while also providing insolvency coverage under the California Insurance Guarantee Association (CIGA). Insurance policies for losses which have not yet occurred are also covered by CIGA, and have been covered by CIGA for many years. Thus, moving from self insurance to insurance could replace a substantial credit risk and risk of delayed payments with the credit risk and timely payment risk of one or more insurers and CIGA. At the extreme, sometimes public entities or agencies completely “go out of business” and there could be no entity to pay self insured losses, especially losses such as asbestos which take years to become known. Assorted mosquito abatement districts, airport authorities, and special districts could be closed down completely, leaving self insured claims which are not yet reported in doubt for a source of payment. If an insured district or authority closes down, the insurer pays for any outstanding or late reported claims.

For input 507, a debenture for workers compensation would be a statement acknowledging workers compensation debt, in this case, a “debt imposed by law”. Assuming a public entity has employees, it is obligated under California statutes to pay workers compensation losses. These losses are obligations of the public entity if the entity is self insured, or the public entity's insurance company if it is insured for workers compensation.

A court may find that a public entity already has a debt related to the liabilities proposed to be insured and financed using bonds, that the debt is imposed by law, and bond financing of insurance is not additional borrowing but is a change in the form of borrowing. If self insured liabilities are acknowledged as equivalent to an existing debt, the bond issue to pay for self insurance can be treated as a way to retire the self insured debt and replace it with debt from the bond issue. In this case, the new bond issue is not counted toward any debt ceilings or borrowing limits. This can be very useful for a public entity approaching its debt limit. If there are large savings from insurance with bond financing, the public entity might reduce it's expenditures, reduce or eliminate cash flow volatility, reduce or eliminate catastrophe risk, and not “use up” borrowing capacity.

In this case, the proposed deal for bond insurance 509 would include cash flows for one or more bonds paying for insurance premiums. Note that there might be one bond or multiple bonds, and that other forms of payment might pay a portion of the premium. In many cases, public entities have set aside money to pay for a portion of the expected liabilities. That money could pay a part of the premium with bonds paying the rest. Bonds could also pay the entire insurance premium, with the public entity using the cash previously set aside for other purposes.

Projected savings, cash flows, and risk factors 511 may come from analysis such as in FIG. 3, or may come from other source, such as actuarial analysis, or a public entity financial analyst, or an investment banking firm. Input 513 includes any private letter ruling(s) from the IRS and any applicable state tax ruling(s). Input 515 is bond counsel opinion, which may include opinions on issues aside from the tax exempt or taxable status of interest on the proposed bonds.

The public entity, authority, pool, or joint powers authority and counsel 501 use information from inputs 503-515 prepare briefs 517 for use in the validation proceeding. The briefs are filed in the Superior Court of the State of California in the appropriate county in step 519. The appropriate county is usually the county in which the public entity is located. In some cases, such as special districts and the State itself, the entity is not located in a single county. In those cases, the briefs are filed with the Superior Court of the county in which the principal office of the public agency is located.

At step 521 the public entity publishes a summons to the general public and may also serve summons to any indispensable parties to the matter before the court.

A validation proceeding is unusual in that the defendant(s) are generally unknown at the time of the filing. A validation proceeding is a proceeding in rem, which means that a summons is made to the general public for anyone who might wish to protest or contest the matters which the public entity is trying to validate. There are potentially two types of summons in a validation proceeding. The first form of summons is always present. A summons is published in “a newspaper of general circulation designated by the court, published in the county where the action is pending and whenever possible within the boundaries of the public agency, and in such other counties as may be ordered by the court, and if there be no such newspaper in any such county or counties then in some adjoining county . . . The summons shall be directed to “all persons interested in the matter of (specifying the matter),” and shall contain a notice to all persons interested in the matter that they may contest the legality or validity of the matter by appearing and filing a written answer to the complaint not later than the date specified in the summons, which date shall be 10 or more days after the completion of publication of the summons.” (California Code of Civil Procedure, Section 861-861.1).

A second form of summons may or may not be present. The court may direct, or the public entity may choose, that certain relevant or indispensable parties be served directly. Such parties are generally parties which are expected to have an interest in the matter before the court. In the example of a bond issue to pay workers compensation premium, parties which might be served directly include: labor unions for employees of the public entity; a state self insurance regulator; or vendors involved in the current self insured program.

In a large percentage of validation proceedings, no one files opposing briefs or contests the validation proceeding. At step 523, if any opposing briefs are filed, these are responded to. In some cases, the public entity might also make changes in their briefs and ask the court to validate the modified briefs.

At step 525, the waiting period for filings expires. This filing period lasts 60 days from the public entity's filing with the court. The court rules on the matter before it. In many cases, unopposed validation proceedings result in judgments which are virtual copies of the public entity's briefs.

Regardless of whether there was any opposition, there is a 30 day appeal period for the judgment at step 527. After the appeal period expires, the judgment of the court is final and the court issues a ruling validating matters relating to the bond issue for insuring one or more liabilities at 529.

After final judgment on the validation proceedings, it is extremely difficult to appeal any finding of the court: “The judgment, if no appeal is taken, or if taken and the judgment is affirmed, shall, notwithstanding any other provision of law including, without limitation, Sections 473 and 473.5, thereupon become and thereafter be forever binding and conclusive, as to all matters therein adjudicated or which at that time could have been adjudicated, against the agency and against all other persons, and the judgment shall permanently enjoin the institution by any person of any action or proceeding raising any issue as to which the judgment is binding and conclusive” (California Code of Civil rocedure, Section 870).

Obtaining One or More Bond Ratings, Obtaining a Bond Guarantee

FIG. 6 is a flowchart showing steps involved in obtaining any bond guarantee insurance and obtaining one or more bond ratings.

Information from various sources is conveyed to or assembled by the public entity, authority, pool, or joint powers authority, and their investment bankers or counsel 601. The information includes: the court ruling from any validation proceedings, input 603; the entity's current budget and financials 605; a statement of sources and uses of funds relating to the bond issue 607; a draft of the bond official statement 609; savings, cash flows, arbitrage analysis or simulations, relating to self insurance and insurance with bond financing, such as might be produced from the process in FIG. 3, input 611; a summary of the entity's currently outstanding debts 613: and a bond counsel opinion and any IRS private letter ruling or state income tax rulings, input 615.

There are several interesting uses of funds which could result from the transaction which might be described in step 607. In many cases, a public entity will have partially funded for future liabilities and those liabilities will be covered by insurance paid for by the bond issue. The funds previously set aside could be used to pay a portion of the insurance premium. Alternatively, the funds set aside could be used for some other purpose (sometimes referred to as “raiding” of funds).

The other use of funds originally set aside to pay for liabilities which will be insured might be related to the original liabilities. For example, the insurance being purchased might be for earthquake coverage with a $100 million limit. Funds previously set aside for that purpose might go to a reserve to cover losses over $100 million, or might be used for earthquake mitigation. Less related uses might be for other risks, such as general liability or workers compensation, or for uninsured and previously unfunded pollution liabilities. Lastly, funds might be used elsewhere for completely unrelated purposes, such as road construction, employee salaries, or balancing the public entity's overall budget.

If the funds previously set aside are being used “responsibly” in the view of rating agencies, it may help obtain a better rating for the bonds. If the funds are merely being “raided” to show a balanced budget in the current year, the rating agencies may see this as a sign of poor management or future problems balancing the budget and issue a lower rating.

In recent years, about 40% of all municipal bond issues sold in the U.S. have been guaranteed by companies such as FSA, AMBAC, and FGIC. The guarantee of payment from a company rated AAA reduces interest expense for the public entity issuing the bond. Some bonds are submitted for review for guarantees and either declined by the guarantee company or the entity elects not to accept the guarantee offer, for reasons such as pricing of the guarantee fees. Bond guarantee underwriters collect information similar to that obtained by bond rating agencies. At 617, a choice is made regarding whether to submit information to one or more bond guarantee underwriters. The processes of bond guarantee underwriting and evaluating offers from guarantee firms are well known to municipal bond investment bankers. A “no” at 617 advances to step 625 without filing for bond guarantee insurance.

A “yes” at 617 advances to 619, where filings are made with one or more bond guarantee firms. Bond guarantee filings may be either competitive bid or negotiated. At step 621, any offers for bond guarantee insurance are reviewed. It is possible that no bond guarantee firm wishes to guarantee a particular bond, at any price. More commonly, there will be at least one bid. At step 623, the bond issuer decides whether to accept any bid for bond guarantee insurance. The process then continues at step 625.

At step 625, the issuer files for ratings from one or more bond rating agencies, such as Moody's, Standard and Poors, or Fitch. Rating agencies have extensive policies and guidelines 627 relating to the manner in which ratings are determined. Currently, at least one rating agency has a distinct policy for rating bonds which have been validated using a California Validation proceeding. This advantageous treatment provides a higher rating for bonds which have been validated by a California court than for many other bonds, such as lease obligation bonds. A copy of a document from Moody's describing it's rating approach for bonds approved using a California Validation proceeding is attached.

The strength of bond counsel opinion, the existence of a private letter ruling from the IRS, and any state ruling(s) regarding state tax exemption may also have an effect on the rating of a particular bond issue. In cases where it was ruled after issuance that a bond issue which was expected to yield tax exempt interest would instead yield taxable interest, bond values have often plummeted and considerable litigation has ensued.

Any bond guarantee insurance will have a substantial effect on the rating of the bond issue; generally the issue will receive the rating of the firm providing the bond guarantee.

At step 629 bond ratings are issued by one or more bond rating agencies. These ratings, and the tax exempt status of the bonds, are likely to be prime determinants of interest costs for the bond issuer. Bond ratings are generally included in the bond official statement and in other marketing information for the bonds.

At step 631 the bonds are issued. Such bonds might be privately placed, or might be sold to the general public. Part or all of the proceeds of the bonds are used to pay insurance premiums; one or more insurance carriers accept one or more premium payments and provide coverage. Portions of the bond issue might go to pay other expenses including, but not limited to: underwriting fees, brokerage fees, premium taxes, bond counsel, financial consultants, filing fees, patent fees, marketing fees, bond guarantee insurance, surety fees, purchase of other securities as investments until later premium payments are made, safety, loss control, and claims administration.

At step 631 part of the funds used to pay insurance premium may come from other sources. For example, many public entities have partially funded for workers compensation losses which have already occurred. The bonds could pay a portion of insurance premiums and funds previously set aside could also pay a portion of premiums. Portions of the premium may be paid over time. For example, a single bond issue might pay premium for three years of medical malpractice coverage and make payments at the beginning of each fiscal year for that year's coverage.

Calculation of Breakeven Interest Rates

FIG. 7 is a flowchart showing methods of calculating one or more breakeven interest rates or breakeven term structures for premium financing. The process in FIG. 7 may be used on its own, or to aid in another process such as step 311 in FIG. 3.

The system 700 includes a computer executable program which in a preferred embodiment is a spreadsheet program 701 such as a Lotus or Excel spreadsheet containing the software which manipulates the input data. It is technically possible to perform these calculations with a handheld calculator, or even paper and pencil. However, hand calculations would be extremely laborious in many cases and are not a preferred embodiment.

Information regarding losses, forecast losses, and forecasts of cash flows for the liabilities if such liabilities were self insured or uninsured is input in 703. A common source of this information is an actuarial study.

The cost of insuring the liability and insured program using bond financing are input in 705. Input 705 also contains at least one proposed bond payout pattern. Examples of such patterns include: level bond payments for a particular number of years (e.g., 10 equal payments); level bond payments where the amount of each payment is fixed, and the number of payments vary (e.g., $1 million per year for as many years as is required to pay off the bond); a percentage savings from the forecast expenditures under self insurance (e.g., 11.3% less than self insurance in each and every year); and a fixed dollar amount savings from the forecast expenditures (e.g., $2.7 million less than self insurance each year).

Tax exempt interest rates expected for the bond issue are input in 707. Such rates might come from a market source for recent bond issues of similar term and rating. For example, a California public entity with a AA rating from Moody's seeking a 5 year tax exempt bond might use the interest rate term structure of a recent 5 year tax exempt bond issued by another AA rated CA public entity. Other potential sources of tax exempt interest rates include, but are not limited to: market sources, such as Bloomberg; a recent bond issuance by the same entity; a U.S. treasury term structure with a tax exempt spread adjustment; a bond underwriter or investment banker; and Municipal Market Data Index (MMD). It is also possible to perform calculations with the term structure set as a constant flat rate.

At 709 any taxable interest rates for the same term, state and rating as for the tax exempt parameters used in 707 are input. Alternatively, approximate expected taxable equivalent interest rates could be calculated from the applicable personal income tax rates of likely buyers of the bond. For example, for the year 2001, a single taxpayer living in California who has a gross income of $100,000 would have an overall marginal (net state and federal) tax rate of 36.963%. Thus, the expected equivalent yield for a California municipal bond which yields 5% tax exempt is 7.93% taxable; 7.93%=5.00%/(100%−36.963%). An exemplary table of taxable equivalent yields is in FIG. 9. Note that there are several states which do not currently have state income taxes.

Steps 711-719 can be performed once, or multiple times using various scenarios. In many cases, scenarios with different payout patterns or base interest rates will be calculated.

At step 711 a base fixed interest rate or term structure is selected. This fixed interest rate or term structure will be used as a basis for breakeven bond present value calculations.

At step 713 a payout pattern is selected. For example, flat payments for 10 years, or a particular percent less than expected self insurance cash flows.

Step 715 is a reminder that interest rates used to calculate a present value of self insured cash flows do not vary when bond interest rates vary. Common selections for interest rates used to discount self insurance cash flows include: interest on public entity investments of similar term to self insured liabilities; commercial paper rates; tax exempt bond rates for bonds of a similar term; and “industry practice” rates recommended by an accounting firm or actuary.

At step 717 all bond interest rates used to calculate interest payments on the bonds are increased, until the present value of bond payments is equal to the present value of self insurance. Note that for this calculation, one set of rates is used to calculate bond interest costs and another set of rates is used to discount those cash flows and calculate a present value. For example, the breakeven rate might be a constant 23% over a 10 year bond term, but principal and interest payments might be discounted at 5% interest, particularly if 5% interest is also being used to calculate the present value of self insurance cost.

The breakeven interest rate can be obtained several methods, including: using simulation, manual iteration by changing the interest rate(s), or by using software tools such as Excel's Solver or Lotus' Backsolver. Both the Excel and Lotus solver tools allow the user to specify the value of a particular cell and vary the values in certain other cells to obtain the specified value. For the breakeven rate, a cell containing the calculation of net savings of the present value of insurance with bond financing versus the present value of self insurance is set to zero. Then, other cells containing one or more interest rates are allowed to vary. One straightforward method of using the solver with a term structure of interest rates is to let all interest rates for various maturities rise or fall proportionately, i.e., if the interest rate for the first year doubles, the interest rate for all other years in the bond issue double. Another method is to let all rates rise or fall by the same number of basis points.

The method of calculation of breakeven interest rates is similar for fixed and floating rate bonds. Simulations based on changes in market interest rates are especially useful for floating rate bonds.

At step 719 a choice is made about performing another scenario. For example, another scenario might use different interest rates or a different payout pattern. Alternative scenarios might also contemplate using a call option on the bonds, or using floating interest rate debt. Possible scenarios have a virtually limitless variety. A “yes” at 719 returns to step 711, where breakeven calculations are repeated for another scenario. A “no” advances to step 721. At 721 the process may continue to another process which uses the breakeven data such as step 313 of FIG. 3, or the analysis may stop.

Sample Cash Flow Exhibit

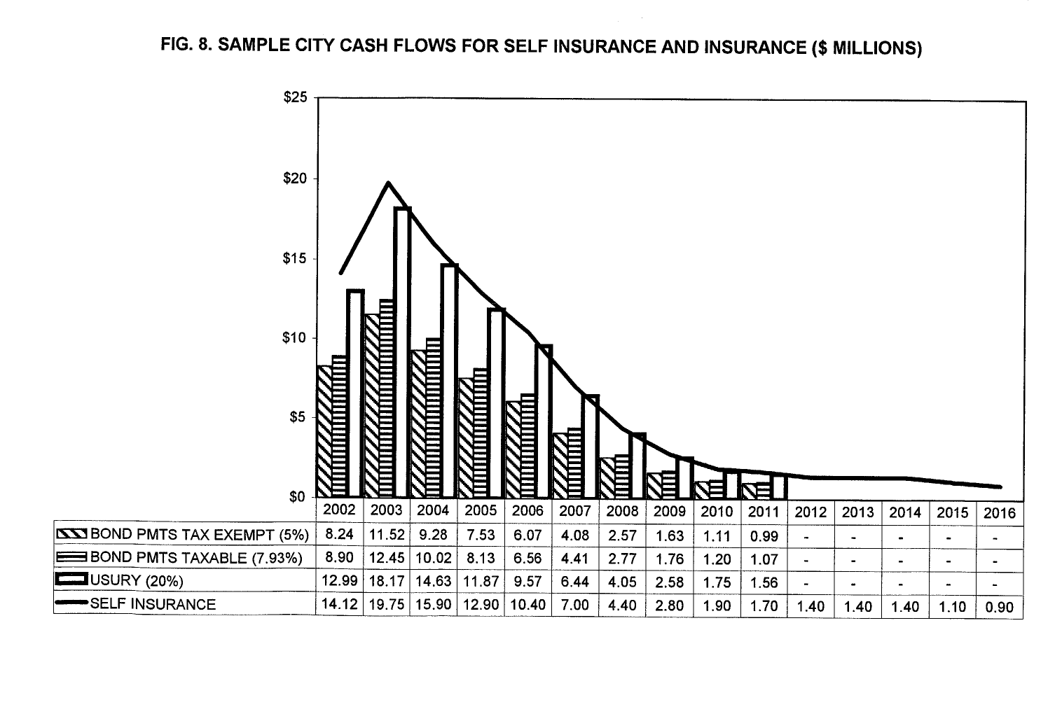

FIG. 8 is a sample output showing cash flows and present values for self insurance versus insurance with bond financing at tax exempt, taxable, and usury borrowing rates, using flat interest rates over the bond term. In this example, very large savings are expected from insuring the currently self insured liability. Such savings could come from many sources and might vary with the liability or liabilities being insured. Some examples of sources of savings include: safety, loss control, ergonomics, loss prevention, claims administration, medical management, litigation management, arbitration, preferred provider networks, fraud reduction, cash flow management, reduction in fines and punitive damages, contractual transfer of liabilities, and reduction of punitive damages through arbitration.

In many cases, a large percentage of the self insured cost could be saved by moving to insurance. Some public entity self insured programs are very poorly run. In other cases, such as environmental liabilities, the public entity may not be managing a liability at all, or even know it exists. For example, in a number of cases, public entities have attempted to minimize or deny the existence of pollution at particular sites and during the period of denial cleanup became more expensive because pollution spread and contaminated a larger area.

While the example in FIG. 8 shows a situation where savings are obtained in each and every budget year, savings will frequently be evaluated on the present values of various alternatives. In many cases, a favorable alternative will result in higher payments than self insurance in at least period. A trivial example is paying an insurance premium in cash up front without bond financing instead of staying self insured and paying a much larger liability over many years.

Taxable Equivalent Bond Yields by State

FIG. 9 is a summary of taxable equivalent bond yields by state. These yields are calculated by setting the aftertax yield of a bond paying taxable interest equal to the yield of a bond paying tax exempt interest. For example, for the year 2001, a single taxpayer living in California who has a gross income of $100,000 would have an overall marginal (net state and federal) tax rate of 36.96%. Thus, the expected equivalent yield for a California municipal bond which yields 5% tax exempt is 7.93% taxable; 7.93%=5.00%/(100%−36.96%). Since state income taxes are deductible from federal income taxes for most high income taxpayers the net tax rate in this example is calculated as: Net Overall Marginal Tax Rate=Federal Marginal Tax Rate+State Marginal Tax Rate * (100%−Federal Marginal Tax Rate), or 30.50%+9.30% * (100%−30.50%)=36.96%.

Sample Breakeven Interest Rate Calculations

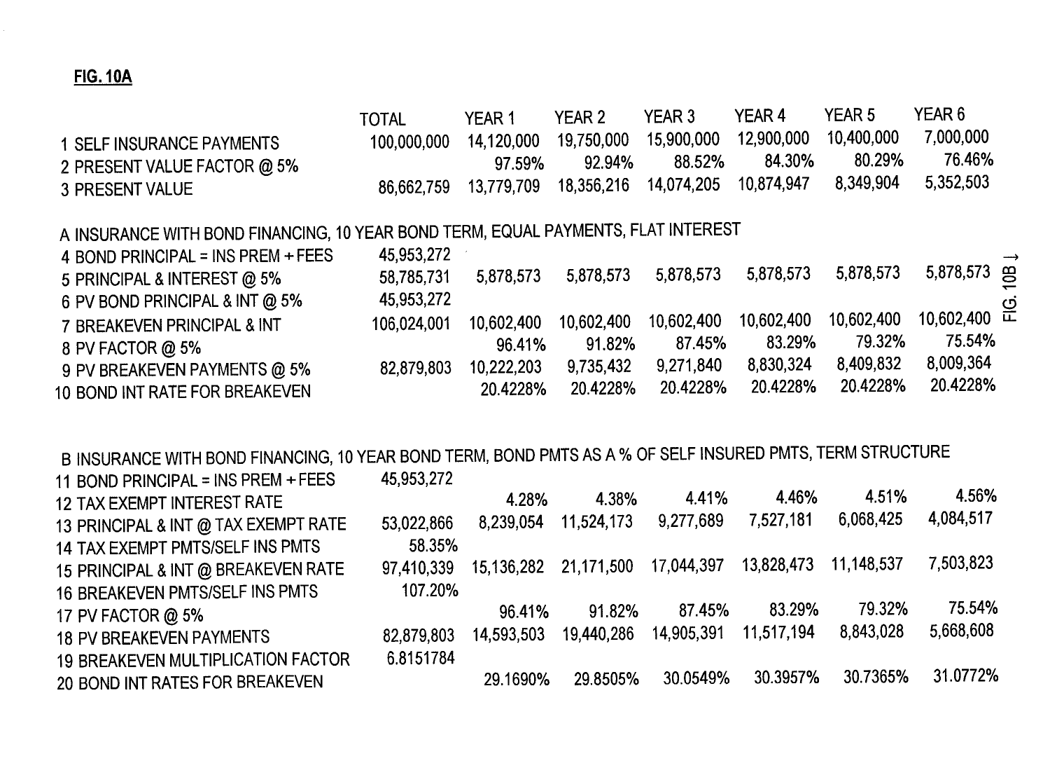

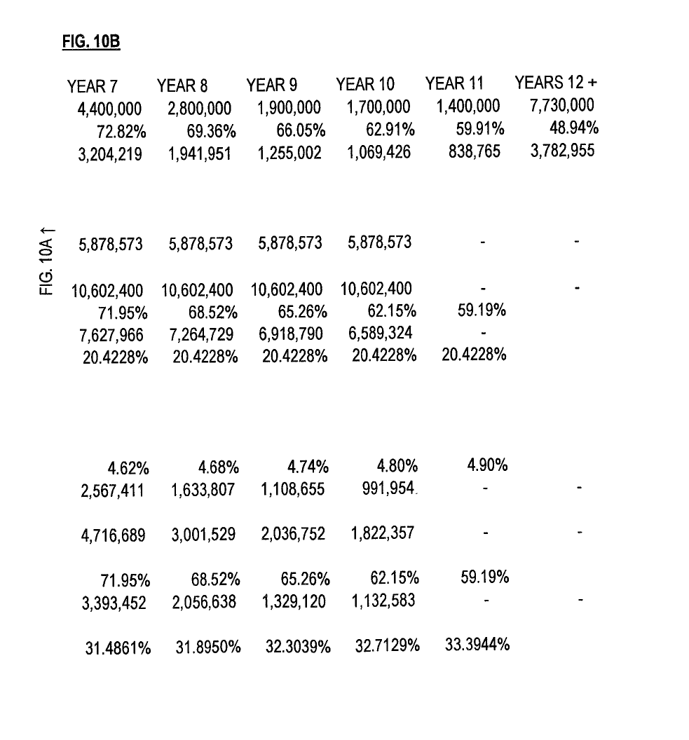

FIG. 10 is a sample output showing calculation of breakeven interest rates. For FIG. 10, the interest rates for discounting self insurance and bond payments were both set at a flat 5%, regardless of term. In this example, undiscounted self insured losses are expected to be $100,000,000, paid over a period of 25 years, shown on line 1. Discounted at 5%, and assuming payments spread equally across any given year, the present value of self insurance is $82,879,803, on line 3. Because losses in later years are small, they have been consolidated to a single column showing losses in year 12 and later. The PV factor for the “Year 12+” adjusts for the actual timing of the cash flows for later years, as shown on line 2.

In the two bond scenarios in FIG. 10, savings from insurance are substantial, and the cost of insurance, plus other fees such as bond issuance and premium taxes is $45,953,272, line 4. The selected payout pattern for the bond in Scenario A is a flat 10 year payout with payments at the middle and end of each year and totals 58,785,731, line 5. Payments at the middle and end of each year lead to slightly different discount factors at 5% than for self insurance, where payments are assumed to be made evenly throughout the year, line 8.

Using the self insurance present value of $82,879,803 as a target, the interest rate on the bonds was varied in iterations to obtain the interest rate where bond principal and interest payments discounted at 5% are exactly $82,879,803 on line 9: the breakeven rate. The breakeven interest rate for this scenario is 20.4227833%, line 10. Breakeven bond payments are in line 7.

For shorter bond financing periods, the breakeven interest rate will be higher than the same payout pattern for longer periods. Using the previous example, but a 5 year bond financing period, the breakeven rate is over 34%.

Scenario B shows a more complex calculation for a bond with a 10 year term, but with annual payments calculated to be in proportion to the expected payout under self insurance. In Scenario B, interest rates have a term structure, line 12, rather than the flat interest rates of Scenario A. Principal and interest using the expected tax exempt term structure is $53,022,866, line 13.

To obtain the breakeven term structure, interest rates are varied in proportion to the tax exempt term structure in line 13 until the present value of principal and interest payments in line 18 is exactly equal to the present value of self insurance payments in line 3, $82,879,803. For this payment pattern, bond principal and interest totals $97,410,339, line 15. Note that for a different payment pattern, the principal and interest totals would be different.

With this particular payment pattern, the bond payout (10 years) is shorter than the self insurance payout (25 years). Thus, the bond payout is 7.2% higher for each of the 10 years than self insurance payments in the same year, line 16.

Because bond payments are made at the middle and end of each year, PV factors for the bonds in Scenario B line 17 are the same as in Scenario A line 8. In order to get the target $82,879,803 present value of bond payments in Scenario B, the interest rates in the term structure in line 12 were changed in iterations. If all interest rates in the term structure are increased by a factor of 6.8151784 in line 19, the target $82,879,803 present value of bond payments is attained. The term structure of bond interest rates for the breakeven calculation is in line 20. Interest rates in line 20 are 6.8151784 times the size of expected tax exempt interest rates in line 12.

There are alternative ways of increasing interest rates to arrive at a breakeven term structure. One alternative is to add the same number of basis points to each interest rate until the target value is attained. If Scenario B is rerun using this method, all interest rates in the term structure must rise by equal amounts to reach the breakeven target, about 2600 basis points in this case.

Listing of Insurable Liabilities

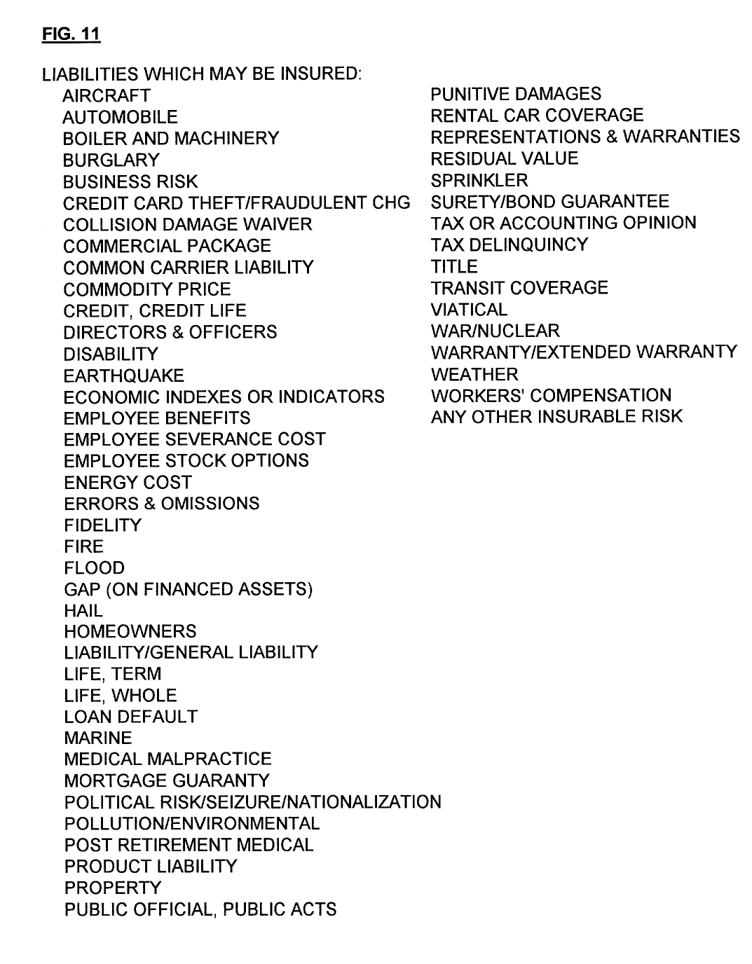

FIG. 11 is a table showing various liabilities which might be insured, such as workers compensation, medical malpractice, pollution liability, general liability and earthquake. Other liabilities might also be insured; the list in FIG. 11 is not intended to be all-inclusive, but rather representative of the breadth of types of liabilities.

I claim:

1. A method for facilitating replacement of one or more liabilities with insurance employing a tax exempt premium financing mechanism, the method comprising the steps of:
employing a computer to create documentation that savings associated with insuring one or more liabilities and using premium financing are sufficient that a public entity would pursue premium financing even if interest on the premium financing would be taxable; and
providing said documentation to obtain one or more opinions relating to the tax exempt status of interest on the proposed premium financing.

2. The method of claim 1, furthermore comprised of:
paying a premium of said insurance with proceeds from said bonds.

3. The method of claim 2, wherein:
said documentation includes a calculation of a present value of said liabilities calculated in consideration of a term structure of interest rates.

4. The method of claim 2, wherein:
said documentation includes a calculation of a present value of insurance with premium financing calculated in consideration of a term structure of interest rates.

5. The method of claim 2, wherein:
the legal opinion is from the Internal Revenue Service.

6. The method of claim 2, wherein:
the legal opinion is from a state tax authority.

7. The method of claim 2, wherein:
the legal opinion is from bond counsel.

8. The method of claim 2, wherein:
said premium financing mechanism is one or more municipal bonds.

9. The method of claim 2, wherein:
said liabilities include self insurance.

10. The method of claim 2, with the additional step of:
providing said opinion to a rating agency.

11. The method of claim 1, with the additional step of:
providing said opinion to a bond guarantee firm.

12. The method of claim 1, with the additional steps of:
issuing said bonds; and
making a payment on said bonds.

13. The method of claim 1, furthermore comprised of:
providing said opinion to an outside party for a regulatory body to obtain an approval for said premium financing mechanism.

14. The method of claim 13, wherein:
said approval is a validation proceeding.

15. The method of claim 14, wherein:
said validation proceeding is a California validation proceeding ruled upon by a California court.

16. The method of claim 1, wherein:
the interest rates required to discourage a public entity from pursuing premium financing are above a relevant usury rate.

17. The method of claim 16, wherein:
said usury rate is the maximum interest rate allowed by law for the party replacing said liability with insurance.

18. The method of claim 16, wherein:
said usury rate is the maximum interest rate allowed by law for a different type of party in the same geographic jurisdiction.

19. The method of claim 16, wherein:
said usury rate is the maximum interest rate allowed by law for a similar party in a different geographic jurisdiction.

20. The method of claim 16 wherein:
said documentation shows that the present value of cash flows of the liabilities is greater than the present value of insurance with bond cash flows when taxable interest rates are used.

21. The method of claim 16, wherein:
said legal opinion is incorporated in an official statement for a bond issue.

22. The method of claim 16 wherein:
said legal opinion is a private letter ruling from the Internal Revenue Service.

23. The method of claim 16 wherein:
said legal opinion is an opinion from bond counsel.

24. The method of claim 16 wherein:
said liabilities include self insurance.

25. The method of claim 2, wherein:
the premium of said insurance is paid in part from sources other than said bonds.

26. The method of claim 2, with the additional step of:
using funds previously set aside for payment of the liabilities for a purpose other than payment of a portion of the liabilities or purchasing insurance.

27. The method of claim 1, wherein:
the insurance includes a California workers compensation special excess policy.

28. A method for obtaining a bond rating on one or more municipal bonds whose proceeds are used to replace one or more liabilities with insurance, the method comprising the steps of:
obtaining a legal opinion regarding tax exempt status of interest paid on said bonds;
providing said legal opinion to a court in a validation proceeding relating to said bonds; and,
obtaining a rating on said bonds used to replace said one or more liabilities with insurance.

29. The method of claim 28, wherein:
said liabilities include self insurance.

30. The method of claim 28, furthermore comprised of the step of:
issuing said bonds.

31. The method of claim 28, furthermore comprised of the step of:
making one or more payments on said bonds.

32. A method for calculating one or more breakeven interest rates used for comparing present values of one or more liabilities with insurance using municipal bond financing wherein:
one or more interest rates are used for discounting the liabilities' cash flows to obtain a present value of liability cash flows;
one or more bond payout patterns are selected; and
one or more interest rates are found for each bond payout pattern, such that the present value of bond cash flows calculated using such interest rates is equal to the present value of the liabilities' cash flows.

33. The method of claim 32 wherein:
said one or more interest rates used for discounting the liabilities' cash flows is a fixed interest rate, regardless of term.

34. The method of claim 32 wherein:
said one or more interest rates used for discounting the liabilities' cash flows consist of interest rates with a term structure.

35. The method of claim 32 wherein:
said one or more interest rates used for discounting bond cash flows is a single fixed interest rate, regardless of term.

36. The method of claim 32 wherein:
said one or more interest rates used for discounting bond cash flows consist of interest rates with a term structure.

37. The method of claim 36 wherein:
said term structure is calculated in consideration of a term structure of tax exempt interest rates; and
each interest rate in the term structure of tax exempt interest rates is multiplied by a constant to obtain the breakeven term structure.

38. The method of claim 32 wherein:
said liabilities include self insurance.

39. The method of claim 32 wherein:
said liabilities include workers compensation self insurance.

40. The method of claim 32 wherein:
said liabilities include general liability.

41. The method of claim 32 wherein:
said liabilities include pollution liability.

42. The method of claim 32 wherein:
said liabilities include medical malpractice.

43. A payment on one or more tax exempt municipal bonds used to replace one or more liabilities with insurance wherein:
documentation produced before bond issuance shows that savings associated with replacing one or more liabilities with insurance using bond financing would exist if said bond financing paid taxable interest rates; and
a legal opinion confirms tax exempt status of interest paid on the bonds.

44. The payment on tax exempt municipal bonds of claim 43 wherein:
said legal opinion is a private letter ruling from the Internal Revenue Service.

45. The payment on tax exempt municipal bonds of claim 43 wherein:
said legal opinion is from bond counsel.

46. The payment on tax exempt municipal bonds of claim 43 wherein:
said documentation furthermore demonstrates that the interest rate(s) at which the present value of self insurance equals the present value of insurance with bond financing are in excess of one or more usury rates.

47. The payment on tax exempt municipal bonds of claim 43 wherein:
said payment is made by a public entity.

48. The payment on tax exempt municipal bonds of claim 43 wherein:
said payment is received by a bondholder.

49. Tax exempt municipal bonds used to pay insurance premium wherein:
documentation produced before bond issuance shows that savings associated with a change from self insurance to insurance with bond financing would exist if said bond financing paid taxable interest rates; and
a legal opinion confirms tax exempt status of interest paid on the bonds.

50. The tax exempt municipal bonds of claim 49 wherein:
said legal opinion is a private letter ruling from the Internal Revenue Service.

51. The tax exempt municipal bonds of claim 49 wherein:
said legal opinion is from bond counsel.

52. The tax exempt municipal bonds of claim 49 wherein:
said documentation furthermore demonstrates that the interest rate(s) at which the present value of self insurance equals the present value of insurance with bond financing are in excess of one or more usury rates.

53. A bond counsel opinion supporting tax exempt status of a municipal bond issue wherein:
said bond counsel opinion is issued in consideration of documentation which shows that savings associated with a replacing one or more liabilities using insurance with bond financing would exist even if said bond financing was taxable and paid taxable interest rates.

54. The bond counsel opinion of claim 53 wherein:
said documentation furthermore demonstrates that the interest rate(s) at which the present value of one or more liabilities equals the present value of insurance with bond financing are in excess of one or more usury rates.
